(19) United States
(12) Patent Application Publication
(10) Pub. No.: US 2014/0162082 A1
(43) Pub. Date: Jun. 12, 2014

(54) COMPOSITION, AN ARTICLE AND A METHOD FOR THE BONDING OF NON-WOVEN SUBSTRATES

(71) Applicant: H.B. FULLER COMPANY, St. Paul, MN (US)

(72) Inventors: Ryan T. Gleason, Shoreview, MN (US); Kevin P. Davis, St. Paul, MN (US); Peter M. Simone, Woodbury, MN (US); Peter Remmers, Hamburg (DE); Mark S. Kroll, Arden Hills, MN (US)

(73) Assignee: H.B. Fuller Company, St. Paul, MN (US)

(21) Appl. No.: 13/780,255

(22) Filed: Feb. 28, 2013

Related U.S. Application Data
(60) Provisional application No. 61/734,583, filed on Dec. 7, 2012.

(51) Int. Cl. B32B 37/12; C09J 123/12

(52) U.S. Cl. CPC B32B 37/1207; C09J 123/12
USPC 428/523; 156/327; 524/583

(57) ABSTRACT

A composition, an article and a method for the bonding of non-woven substrates is disclosed. The composition includes solid particles comprising one or more polymers which are emulsified, dispersed and or suspended in a fluid carrier. The composition forms a molten blend when energy activated at temperatures in excess of 60° C. (140° F.).

### CROSS-REFERENCE TO RELATED APPLICATIONS

This application claims the benefit of U.S. Provisional Application No. 61/734,583 filed Dec. 7, 2012, which is incorporated herein.

### BACKGROUND

Adhesives are often used to bond substrates together so as to maintain the two substrates in a fixed relation to each other. In the area of industrial adhesives, hot melt adhesives are commonly used to bond together a wide variety of articles including articles comprising non-woven substrates e.g. disposable diapers, sanitary napkins, medical dressings, etc.

Hot melt adhesives are applied at elevated temperature of from about 107° C. (225° F.) to about 191° C. (375° F.). The necessary equipment to keep the hot melt at the elevated temperature includes pre-melters, tank, and heated hoses. There is a significant upkeep involved with this equipment

It would be desirable to have an adhesive composition that could be shipped and supplied to the customer as a room temperature fluid, put in a tank and pumped as a room temperature fluid, but then change form with at least heating to become a molten blend that can be used to bond two substrates together and then cool to a fused solid material.

It would be further desirable if such a composition could be applied to a first substrate at a high line speed and result in a strong bond between a first substrate and a second substrate.

### SUMMARY

In one aspect, the invention includes a disposable article including: a nonwoven substrate; and a composition including, at some point prior to application, a solid particle comprising a polymer; and a liquid carrier into which the solid particle is emulsified, dispersed and/or suspended; wherein: the composition is a fluid at room temperature; and wherein the composition forms a substantially homogeneous, molten blend when energy activated at a processing temperature in excess of 140° F.; the substantially homogenous molten blend becomes a fused solid material when it cools to room temperature; and wherein the composition provides a peel force of greater than zero when tested at room temperature at a coat weight of about 6.2 grams/m according to the Peel Force Test Method.

In some embodiments, the substantially homogeneous, molten blend has a viscosity of less than 15,000 cps at 350° F., or even greater than 10,000 cps at 350° F. In another embodiment, the liquid carrier is selected from the group consisting of mineral oil, naphthenic oil and paraffinic oil. In other embodiments, the polymer is a metallocene catalyzed polyolefin. In some embodiments, the composition additionally comprises a tackifying agent. In other embodiments, the metallocene catalyzed polyolefin comprises greater than 50 percent by weight polypropylene.

In some embodiments the substantially homogeneous, molten blend is applied as a foam. In other embodiments, the substantially homogeneous, molten blend is applied as a spray. In another embodiment, the article is selected from a group consisting of disposable diapers, sanitary napkins, medical dressings, bandages, surgical pads, drapes, gowns, and meat-packing products. In other embodiments, the composition comprises a superabsorbent.

In another aspect, the invention includes a method of forming a disposable article including: obtaining a composition including: a first solid particle comprising a first polymer; and a liquid carrier into which the solid particles are emulsified, dispersed and/or suspended; wherein: the composition is a fluid at room temperature; and wherein the composition forms a substantially homogeneous, molten blend when energy activated at a processing temperature in excess of 140° F.; the substantially homogenous molten blend becomes a fused solid material when it cools to room temperature; and applying the composition to a first substrate using an application system comprising a positive displacement pump; and applying a second substrate on top of the composition, such that the composition forms a bond between the first and second substrate.

In some embodiments, the application system further includes a reactor. In other embodiments, the composition is pre heated prior to entering the reactor. In another embodiment, the application system further includes a heated hose. In some embodiments, the composition is applied to the first substrate as a spiral spray. In still other embodiments, the composition is applied to the first substrate as it is moving at speeds of from about 1500 ft/min to about 3000 ft/min and the composition is applied at a coat weight of from about 0.5 g/m² to about 40 g/m²

In one aspect the invention includes a composition including at least one of an emulsion, dispersion, and suspension comprising, a liquid carrier selected from the group consisting of oil, olefin oligomers, polybutene, polyisoprene, and combinations thereof, and a solid particle comprising a metallocene catalyzed polymer comprising greater than 50% by weight polypropylene. In one embodiment, the composition has a storage modulus of less than about 1×10⁶ Pa at 60° C. after cooling from a molten blend. In another embodiment, the composition is fluid at room temperature.

In another aspect the invention includes a disposable article including: a nonwoven substrate; and a composition including, at a point prior to application, at least one of an emulsion, dispersion, and suspension comprising, a liquid carrier selected from the group consisting of oil, olefin oligomers, polybutene, polyisoprene, and combinations thereof, and a solid particle comprising a polymer, the composition exhibiting a peel force of greater than zero when tested at room temperature at a coat weight of about 6.2 grams/m² according to the Peel Force Test Method.

### GLOSSARY

In reference to the invention, these terms have the meanings set forth below:

The term “room temperature” refers to an indoor ambient air temperature of from about 15.6° C. (60° F.) to about 32.2° C. (90° F.).

The term “fluid” refers to a composition that continually flows or deforms under an applied sheer stress.

### DETAILED DESCRIPTION

The compositions according to this invention comprise solid particles comprising one or more polymers, which are emulsified, dispersed and or suspended in a liquid carrier.

At some point prior to application, the composition is fluid at room temperature.

The composition forms a substantially homogeneous, molten blend when energy activated at a processing temperature in excess of 60° C. (140° F.). The substantially homogenous molten blend becomes a fused solid material when it cools to room temperature. The fused solid material can be thermoplastic. The composition can be an adhesive.

The fluid composition can have good storage stability resulting in a viscosity increase of less than or equal to about 200%, less than or equal to about 100%, or even less than about 50% when aged for 24 hours, 96 hours, or even 1 week, according to the Storage Stability Test method

The fused solid material can have a storage modulus (G′) of less than about 1×10⁶ Pa at 60° C. (140° F.), less than about 5×10⁵ Pa at 60° C. (140° F.), or even less than about 1×10⁵ Pa at 60° C. (140° F.).

The substantially homogeneous molten blend has a melt viscosity at 177° C. (350° F.) of less than about 15,000 cps, less than about 10,000 cps, less than about 7000 cps, or even less than about 5000 cps. Alternately the substantially homogeneous blend has a melt viscosity at 177° C. (350° F.) of greater than 10,000 cps.

### Solid Particle/s

The composition includes at least one kind of solid particle. The total amount of solid particle/s present in the composition is at least about 10% by weight, at least about 20% by weight, at least about 30% by weight, between about 10% and about 70% by weight, or even between about 15% and about 60% by weight.

The solid particle/s have an average diameter of less than about 500 um, less than about 300 um, or even less than about 100 um.

The solid particle/s can include one or more polymers. The polymers can be derived from at least one of ethylene, propylene or butene. The polymers can further be derived from additional monomers such as styrene, acrylic acid and its derivatives, methacrylic acid and its derivatives, higher order polyolefins, acid anhydrides (e.g. maleic anhydride), isoprene, butadiene, vinyl esters (e.g. vinyl acetate), vinyl ethers, and hydrogenated versions thereof. The polymer can be derived from any combination of monomers listed herein.

The polymers can have a melt index as tested by ASTM D 1238 (190° C./2.16 kg) of less than 50 g/10 minutes, less than 20 g/10 minutes, or even less than 10 g/10 minutes.

In some embodiments, two or more polymers can be used having different melt indices.

At least one of the polymers can be a metallocene catalyzed polymer. The metallocene catalyzed polymer can be based on ethylene. Alternately, the metallocene catalyzed polymer can be based on propylene. The polymer can contain at least about 50% by weight polypropylene, at least about 70% by weight polypropylene, or even at least about 90% by weight polypropylene.

Useful metallocene catalyzed polymers include ENGAGE 8200 (available from Dow Chemical Company (Houston, Tex.)) and VISTAMAXX™ 3980FL and VISTAMAXX™ 3000 (available from ExxonMobil Chemical (Houston, Tex.)).

### Liquid Carrier

The liquid carrier is a liquid phase material at room temperature. The liquid carrier can be low in odor so as to not contribute to the odor of the final article made with the composition. Suitable materials for the liquid carrier include plasticizers, e.g., naphthenic oils, paraffinic oils (e.g., cycloparaffin oils), mineral oils, phthalate esters, adipate esters, olefin oligomers (e.g., oligomers of polypropylene, polybutene, and hydrogenated polyisoprene), polybutenes, polyisoprene, hydrogenated polyisoprene, polybutadiene, benzoate esters, animal oil, plant oils (e.g. castor oil, soybean oil), derivatives of oils, glycerol esters of fatty acids, polyesters, polyethers, lactic acid derivatives and combinations thereof.

The liquid carrier is present at least about 20% by weight, at least about 30% by weight, between about 20% and about 70% by weight, or even between about 30% and about 60% by weight.

Useful commercially available liquid carriers include plasticizers sold under the NYFLEX series of trade designations including NYFLEX 222B from Nynas Corporation (Houston, Tex.), KAYDOL OIL from Sonneborn (Tarrytown N.Y.) PARAPOL polybutene from Exxon Mobil Chemical Company (Houston, Tex.), OPPANOL polyisobutylene from BASF (Ludwigsjhafen, Germany), KRYSTOL 550 mineral oil from Petrochem Carless Limited (Surrey, England), CALSOL 550 oil from Calumet Specialty Products Partners, LP (Indianapolis, Ind.), PURETOL 15 mineral oil from Petro Canada Lubricants Inc. (Mississauga, Ontario) and RBD soybean oil from Archer Daniels Midland Company.

### Tackifying Agent

Useful tackifying agents have Ring and Ball softening point of less than about 140° C., less than about 130° C., less than about 100° C., or even between about 100° C. to about 140° C. The tackifying agent can be fluid or solid at room temperature. Suitable classes of tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin. Examples of useful polyterpene resins include polyterpene resins having a softening point, as determined by ASTM method E28-58T, of from about 10° C. to about 140° C., hydrogenated polyterpene resins, and copolymers and terpolymers of natural terpenes (e.g. styrene-terpene, alpha-methyl styrene-terpene and vinyl toluene-terpene). Examples of useful aliphatic and cycloaliphatic petroleum hydrocarbon resins include aliphatic and cycloaliphatic petroleum hydrocarbon resins having Ring and Ball softening points of from about 10° C. to about 140° C. (e.g., branched and unbranched C5 resins, C9 resins, and C10 resins) and the hydrogenated derivatives thereof.

Useful tackifying agents are commercially available under a variety of trade designations including, e.g., the ESCOREZ series of trade designations from Exxon Mobil Chemical Company (Houston, Tex.) including ESCOREZ 5400, ESCOREZ 5415, ESCOREZ 5600, ESCOREZ 5615, and ESCOREZ 5690, the EASTOTAC series of trade designations from Eastman Chemical (Kingsport, Tenn.) including EASTOTAC H-100R, EASTOTAC H-100L, and EASTOTAC H130W, the WINGTACK series of trade designations from Cray Valley HSC (Exton, Pa.) including WINGTACK 86, WINGTACK EXTRA, and WINGTACK 95 and the PICCOTAC and KRISTALEX series of trade designations from Eastman Chemical Company (Kingsport, Tenn.) including, e.g., PICCOTAC 8095 and KRISTALEX 3100.

The composition can include at least about 10% by weight, at least about 20% by weight, from about 5% by weight to about 60% by weight, from about 10% by weight to about 50% by weight, or even from about 10% by weight to about 40% by weight tackifying agent.

### Wax

The composition can include a wax. Useful classes of wax include, e.g., paraffin waxes, microcrystalline waxes, high density low molecular weight polyethylene waxes, by-product polyethylene waxes, polypropylene waxes, Fischer-Tropsch waxes, oxidized Fischer-Tropsch waxes, functionalized waxes such as acid, anhydride, and hydroxy modified waxes, animal waxes, vegetable waxes (e.g. soy wax) and combinations thereof. Useful waxes are solid at room temperature and preferably have a Ring and Ball softening point of from 50° C. to 170° C. Useful waxes are commercially available from a variety of suppliers including EPOLENE N and C series of trade designations from Westlake Chemical Corporation (Houston, Tex.) including e.g. EPOLENE N-21 and the LICOCENE series of trade designations from Clariant International Ltd. (Muttenz, Switzerland) including e.g. TP LTCOCENE PP 6102.

The composition can include less than about 20% by weight, less than about 15% by weight, or even less than about 10% by weight of a wax.

### Additional Components

The composition optionally includes additional components including, e.g., blowing agents (e.g. water), stabilizers, antioxidants, additional polymers (e.g. polyesters, polyurethanes and polyamides), adhesion promoters, ultraviolet light stabilizers, rheology modifiers, biocides, corrosion inhibitors, dehydrators, colorants (e.g., pigments and dyes), fillers, surfactants, flame retardants, superabsorbents and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (Florham Park, N.J.), and ETHYL 702 4,4′-methylene bis(2,6-di-tert-butylphenol). When present, the composition preferably includes from about 0.1% by weight to about 2% by weight antioxidant.

### Making the Composition

The composition can be made at room temperature. The solid particles can be added to the liquid with mixing until the composition is homogeneous.

If a tackifying agent is used it can be blended into the liquid (optionally with heat) in a premix. The ratio of tackifying agent to liquid in the premix can range from 0.2:1 to 1:0.5. If the premix is heated, the temperature is reduced to at least 60° C. (140° F.) prior to adding the solid particles. If wax is used it can also be blended into the premix. Alternately wax or tackifier can be added as an additional solid particle.

Other optional ingredients (e.g. antioxidants, ultraviolet light stabilizers, etc.) can be included in the premix; alternately they can be added to the liquid after the solid particles.

### Article

The composition can be applied to (i.e. such that it is in direct contact with) or incorporated in a variety of substrates including, e.g., films (e.g., polyolefin (e.g., polyethylene and polypropylene) films), release liners, porous substrates, cellulose substrates, sheets (e.g., paper, and fiber sheets), paper products, woven and nonwoven webs, fibers (e.g., synthetic polymer fibers and cellulose fibers) and tape backings.

The composition is also useful in a variety of applications and constructions including, e.g., disposable articles including, e.g., disposable diapers, sanitary napkins, medical dressings (e.g., wound care products) bandages, surgical pads, drapes, gowns, and meat-packing products, paper products including, e.g., paper towels (e.g., multiple use towels), toilet paper, facial tissue, wipes, tissues, towels (e.g., paper towels), sheets, mattress covers, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue).

The composition is useful on substrates made from a variety of fibers including, e.g., natural cellulose fibers such as wood pulp, cotton, silk and wool; synthetic fibers such as nylon, rayon, polyesters, acrylics, polypropylenes, polyethylene, polyvinyl chloride, polyurethane, and glass; recycled fibers, and various combinations thereof.

The article can be a disposable article including a composition including a solid particle comprising a polymer; and a liquid carrier into which the solid particle is emulsified, dispersed and/or suspended; where the composition is a fluid at room temperature; and where the composition forms a substantially homogeneous, molten blend when energy activated at a processing temperature in excess of 60° C. (140° F.); the substantially homogenous molten blend becoming a fused solid material when it cools to room temperature; and wherein the composition provides a peel force of greater than zero when tested at room temperature at a coat weight of about 6.2 grams/m² according to the Peel Force Test Method.

The article can also be a disposable article including a nonwoven substrate; and a composition including, at a point prior to application, at least one of an emulsion, dispersion, and suspension comprising, a liquid carrier selected from the group consisting of oil, olefin oligomers, polybutene, polyisoprene, and combinations thereof, and a solid particle comprising a polymer, the composition exhibiting a peel force of greater than zero when tested at room temperature at a coat weight of about 6.2 grams/m² according to the Peel Force Test Method.

Various application techniques can be used to apply the composition to a substrate including, e.g., slot coating, spraying including, e.g., spiral spraying and random spraying, screen printing, foaming, engraved roller, extrusion and meltblown application techniques.

The application line speed varies from about 3.0 m/min (10 ft/min) to about 914 m/min (3000 ft/min), from about 152 m/min (500 ft/min) to about 914 m/min (3000 ft/min), or even greater than about 762 m/min (2500 ft/min). The coat weight can vary from about 0.1 g/m² to about 1,000 g/m², from about 0.5 g/m² to about 40 g/m², or even from about 60 g/m² to about 150 g/m².

Examples of useful line speed/coat weight parameters for disposable articles include line speeds ranging from about 3.0 nm/min (10 ft/min) to about 762 m/min (2500 ft/min) resulting in coat weights from about 0.5 g/m² to 200 g/m². Examples of useful line speed/coat weight parameters for disposable diapers include line speeds ranging from about 30 m/min (100 ft/min) to about 914 m/min (3,000 ft/min), or even from about 457 m/min (1500 ft/min) to about 914 m/min (3000 ft/min) and coat weights ranging from about 0.50 g/m² to about 100 g/m².

### Methods of Use

The composition is stored at room temperature in a reservoir. When it is time to use the composition, it is pumped through a pressurizing apparatus (e.g. pump) into a vessel. From the vessel, the composition enters the reactor. The reactor heats and mixes the composition. The heat can be generated by any means. When the composition exits the reactor, it is a molten blend. The molten blend then enters the dispenser for application.

In FIG. 8 incorporated herein from WO 2009/108685 A1 there is a schematic representation of various elements/order of elements that can be utilized to deliver the composition to a reactor.

This invention also includes a method of forming a disposable article including obtaining a composition including: a first solid particle comprising a first polymer; and a liquid carrier into which the first solid particles are emulsified, dispersed and/or suspended; wherein: the composition is a fluid at room temperature; and wherein the composition forms a substantially homogeneous, molten blend when energy activated at a processing temperature in excess of 60° C. (140° F.); the substantially homogenous molten blend becomes a fused solid material when it cools to room temperature; applying the composition to a first substrate using an application system comprising a positive displacement pump and applying a second substrate on top of the composition, such that the composition forms a bond between the first and second substrate.

The positive displacement pump can be a rotary type pump or a reciprocating type pump. When the positive displacement pump is a rotary type pump it can be an internal gear pump, an external gear pump, an eccentric disc pump, a lobe pump, a peristaltic pump, a progressive cavity pump, a screw pump or a vane pump. The positive displacement pump offers a near constant flow rate of the composition at a higher pressure to lower pressure to enable more consistent application of lower coat weights. In a preferred embodiment, the pump is an internal gear pump.

The application system can include a reactor (sometimes known as a heat exchanger) to energy activate the composition and/or a heated pipe/vessel to energy activate the composition. In some, embodiments the composition is pre heated prior to entering the reactor. Suitable reactors are known in the art and include those reactors disclosed in WO 2009/108685 A1, U.S. Pat. No. 7,221,859 B2 and U.S. Pat. No. 7,623,772 B2 and incorporated by reference herein.

The invention will now be described by way of the following examples. All parts, ratios, percents and amounts stated in the Examples are by weight unless otherwise specified.

### Examples

### Test Procedures

Test procedures used in the examples and throughout the specification, unless stated otherwise, include the following.

### Viscosity Test Method

Viscosity is determined in accordance with ASTM D-3236 entitled, “Standard Test Method for Apparent viscosity of Adhesives and Coating Materials,” (Oct. 31, 1988), using a Brookfield Thermosel viscometer Model RVDV 2 and a number 27 spindle. The results are reported in centipoise (cps).

### Storage Stability Test Method

1.) An initial viscosity of the composition is measured at a temperature of 21.1° C. (70° F.) using the Viscosity Test Method.

2.) 200 grams of the composition is placed in a 400-ml glass jar and a plastic lid is screwed in place.

3.) The jar is aged at 48.9° C. (120° F.) for 4 weeks.

4.) A sample of the composition is removed at various times during aging and the viscosity is measured at a temperature of 21.1° C. (70) using the Viscosity Test Method.

5.) A percent change in viscosity (at the aged time) is calculated according to the following equation:

((Final viscosity−Initial viscosity)/(Initial viscosity))*100

### Storage Modulus Test Method

The fused solid material of the compositions was tested using the RDA3-Rheometric Dynamic Analyzer, The samples were prepared and tested according to ASTM D-5279-93 entitled; “Measuring the Dynamic Mechanical Properties of Plastics in Torsion”, and ASTM D-4440-93, entitled; “Rheological Measurement of Polymer Melt Using Dynamnic Mechanical Properties”. The three samples were subjected to a temperature ramp test from −20° C. to 120° C. The 25-mm parallel plate geometry was used along with a ramp rate of 3° C./min and a frequency of 10 rad/sec.

### Test Sample Preparation

The composition is applied in such a way so as to mix and heat sufficiently to form a homogeneous molten blend prior to application.

A multi-bead applicator and laminator are set to a nip pressure of 15 psi, and minimal rewind and unwind tensions that will not stretch the film used in the samples. A 1 mil thick white embossed polyethylene film is passed through the applicator. The film is a blend of linear low density polyethylene and low density polyethylene (e.g., DH-284 PE MICROFLEX Embossed Non-Breathable film having an emboss gauge of 1.8 mils (as determined according to ASTM D374), 70 grams/inch F50 impact strength (as determined according to ASTM D1709), 670% elongation at break in the machine direction (as determined according to ASTM D882), 920% elongation at break in the cross direction (as determined according to ASTNM D882), 590 grams/inch tensile at 10% elongation in the machine direction (as determined according to ASTM D882), 590 grams/inch tensile at 10% elongation in the cross direction (as determined according to ASTM D882), 2500 grams/inch ultimate tensile in the machine direction (as determined according to ASTM D882), and 1700 grams/inch ultimate tensile in the cross direction (as determined according to ASTM D882), which is available from Clopay Plastic Products Company, Inc., (Cincinnati, Ohio) or equivalent thereof), which has been corona treated on one side thereof to a surface energy of about 38 dynes per square centimeter (dynes/cm²) (as measured using dynes pens). A slot coat of the sample composition is applied by the applicator to the corona treated side of the polymer film and then the film and the sample composition are nipped to a 15 grams/square meter (g/m²) basis weight spunbond polypropylene nonwoven web having a 7 mil Thwing-Albert thickness (e.g., UNIPRO 45 nonwoven web from Midwest Filtration Company) to form a laminate.

The film is coated at the specified speed and coat weight. A sufficient amount of laminate is prepared such that 60 inches of representative lamination can be collected for testing.

### Peel Force Test Method

Peel force is determined using ASTM D1876-01 entitled; “Test Method for Determining Peel Resistance of Adhesive (T-Peel Test Method),” with the exception that the test is run at a rate of 12 inches per minute, instead of 10 in per minute, over a period of 10 seconds, and 7 replicates are run instead of the 10 specified in ASTM D1876. The samples are run on an INSTRON type-test instrument. The test samples are prepared as described in the Test Sample Preparation at the specified speed with a 0.5 inch wide spiral spray pattern. The average peel force over 10 seconds of peeling is recorded, and the results are reported in grams. The initial peel force is measured 24 hours after the laminate is prepared. The two week peel force is measured after the sample has been subjected to accelerated aging at 50° C. and 50% relative humidity for two weeks. The four week peel force is measured after the sample has been subjected to accelerated aging at 50° C. and 50% relative humidity for four weeks.

### Sample Preparation

Samples are prepared for testing by cutting the laminate into 6 inch long sections. The peel force is measured across the entire width the adhesive; therefore, the sample width depends on application type and coat weight. At one end of the sample, the substrates should be separated to allow for the coated substrate to be inserted into the stationary jaw of the test instrument, and the laminated substrate to be inserted in to the moving jaw of the test instrument

TABLE 1
Premix Composition

| | Premix 1 | Premix 2 |
|---|---|---|
| | (Weight %) | (Weight %) |
| PURETOL 15 | 25 | 50 |
| RBD SOYBEAN OIL | 25 | |
| ESCOREZ 5400 | 50 | 45 |
| EPOLENE N21 | | 5 |

TABLE 2
Examples

| | | Example 1 | Example 2 |
|---|---|---|---|
| | Comparative | (weight | (weight |
| | 1* | %) | %) |
| VISTAMAXX 3000 | | 10 | 10 |
| VISTAMAXX 6102 | | 10 | 10 |
| Premix 1 | | 79 | |
| Premix 2 | | | 79 |
| Water | | 1 | 1 |
| Molten Viscosity (at 350° F.) | 9300 | NT | 10500 |
| Initial Peel Force (grams Force) | 0 | NT | 30 |
| Run at line speed of 182.9 m/min | | | |
| (600 ft/min) with a coat weight | | | |
| of 6.2 g/m² | | | |
| Storage Modulus at 25° C. (Pa) | NA | 1.15 × 10⁴ | 2.15 × 10⁵ |
| Storage Modulus at 38° C. (Pa) | 2.0 × 10⁶ | 6.66 × 10³ | 1.15 × 10⁵ |
| Storage Modulus at 60° C. (Pa) | 1.75 × 10⁶ | 2.2 × 10³ | 4.7 × 10⁴ |
| Storage Stability at | | | |
| 24 hrs (%) | NT | 182 | NT |
| 96 hrs (%) | NT | 190 | NT |

*Comparative 1 is LM1259 commercially available from HB Fuller Company.
NT (Not Tested)

To make the premix, all materials were put in a pint size metal mixing can and placed in a heating mantle (Glas-Col, Terre Haute, Ind.). The mantel was heated to 149° C. (300° F.) While heating, the premix was blended with an upright Stirrer Type RZRI mixer (Caframo, Wiarton, Ontario, Canada). Once the mantle reached 149° C., the heat was turned off and mixing continued until the sample was cooled back to room temperature.
Once the premix was cooled to room temperature, the polymers, in particulate form, were added. The sample was mixed until homogeneous.
Other embodiments are within the claims.

What is claimed is:

1. A disposable article comprising:
a nonwoven substrate; and
a composition comprising, at some point prior to application,
a solid particle comprising a polymer;
and a liquid carrier into which the solid particle is emulsified, dispersed and/or suspended;
wherein:
the composition is a fluid at room temperature;
and wherein the composition forms a substantially homogeneous, molten blend when energy activated at a processing temperature in excess of 140° F.;
the substantially homogenous molten blend becomes a fused solid material when it cools to room temperature; and wherein
the composition provides a peel force of greater than zero when tested at room temperature at a coat weight of about 6.2 grams/m² according to the Peel Force Test Method.

2. The article of claim 1 wherein the substantially homogeneous, molten blend has a viscosity of less than 15,000 cps at 350° F.

3. The article of claim 1 wherein the substantially homogeneous, molten blend has a viscosity of greater than 10,000 cps at 350° F.

4. The article of claim 1 wherein the liquid carrier is selected from the group consisting of mineral oil, naphthenic oil and paraffinic oil.

5. The article of claim 1 wherein the polymer is a metallocene catalyzed polyolefin.

6. The article of claim 5 wherein the composition additionally comprises a tackifying agent.

7. The article of claim 5 wherein the metallocene catalyzed polyolefin comprises greater than 50 percent by weight polypropylene.

8. The article of claim 1 wherein said substantially homogeneous, molten blend is applied as a foam.

9. The article of claim 1 wherein said substantially homogeneous, molten blend is applied as a spray.

10. The article of claim 1 wherein the article is selected from a group consisting of disposable diapers, sanitary napkins, medical dressings, bandages, surgical pads, drapes, gowns, and meat-packing products.

11. The article of claim 1 wherein the composition comprises a superabsorbent.

12. A method of forming a disposable article comprising:
a) obtaining a composition comprising:
a first solid particle comprising a first polymer;
and a liquid carrier into which the solid particles are emulsified, dispersed and/or suspended;
wherein:
the composition is a fluid at room temperature;
and wherein the composition forms a substantially homogeneous, molten blend when energy activated at a processing temperature in excess of 140° F.;
the substantially homogenous molten blend becomes a fused solid material when it cools to room temperature; and
b) applying the composition to a first substrate using an application system comprising a positive displacement pump; and
c.) applying a second substrate on top of the composition, such that the composition forms a bond between the first and second substrate.

13. The method of claim 12 wherein the application system further comprises a reactor.

14. The method of claim 13 wherein the composition is pre heated prior to entering the reactor.

15. The method of claim 12 further comprising a heated hose.

16. The method of claim 12 wherein the composition is applied to the first substrate as a spiral spray.

17. The method of claim 12 wherein the composition is applied to the first substrate as it is moving at speeds of from about 1500 ft/min to about 3000 ft/min and the composition is applied at a coat weight of from about 0.5 g/m² to about 40 g/m².

18. A composition comprising:
at least one of an emulsion, dispersion, and suspension comprising, a liquid carrier selected from the group consisting of oil, olefin oligomers, polybutene, polyisoprene, and combinations thereof, and a solid particle comprising a metallocene catalyzed polymer comprising greater than 50% by weight polypropylene.

19. The composition of claim 18 wherein the composition has a storage modulus of less than about 1×10⁶ Pa at 60° C. after cooling from a molten blend.

20. The composition of claim 18 wherein the composition is fluid at room temperature.

21. A disposable article comprising:
a nonwoven substrate; and
a composition comprising, at a point prior to application, at least one of an emulsion, dispersion, and suspension comprising, a liquid carrier selected from the group consisting of oil, olefin oligomers, polybutene, polyisoprene, and combinations thereof, and a solid particle comprising a polymer.
the composition exhibiting a peel force of greater than zero when tested at room temperature at a coat weight of about 6.2 grams/m² according to the Peel Force Test Method.
